(19) United States
(12) Patent Application Publication
(10) Pub. No.: US 2024/0276976 A1
(43) Pub. Date: Aug. 22, 2024

(54) DEVICE FOR VITRIFYING AND DELIVERING VITRIFIED BIOACTIVE AGENTS

(71) Applicant: UPKARA, INC., Ann Arbor, MI (US)

(72) Inventors: Mary Ratzlaff, Ann Arbor, MI (US); Pravansu Mohanty, Ann Arbor, MI (US); Zhuoran Wang, Ann Arbor, MI (US); Arun Reddy, Ann Arbor, MI (US); Laura Bronsart, Ann Arbor, MI (US)

(21) Appl. No.: 18/567,811

(22) PCT Filed: Jul. 1, 2022
(86) PCT No.: PCT/US2022/035892

§ 371 Date: Dec. 7, 2023

Related U.S. Application Data
(60) Provisional application No. 63/217,460, filed on Jul. 1, 2021.
(60) Provisional application No. 63/217,458, filed on Jul. 1, 2021.

(51) Int. Cl. A01N 1/02

(52) U.S. Cl. CPC A01N 1/0284; A01N 1/0252

(57) ABSTRACT

A device for vitrifying bioactive agents and delivering vitrified bioactive agents includes a top housing having an inner and outer surface and a perimeter. A bottom housing has an inner and outer surface and a perimeter. An interconnect structure interconnects the housings to define an interior volume between the inner surfaces of the top and bottom housings. The bottom housing may be formed of a flexible material such that the bottom housing is deformable between a first configuration wherein the bottom housing is curved away from the top housing, and a second configuration wherein the bottom housing is curved toward the top housing. The interconnect structure may interconnect the top and bottom housing in a first position wherein the inner surfaces are spaced apart by a first distance, and in a second position wherein the surfaces are spaced apart by a second distance that is less than the first distance.

### CROSS REFERENCE TO RELATED APPLICATION

This application claims priority from U.S. Provisional Application No. 63/217,460 filed Jul. 1, 2021 and entitled DEVICE FOR VITRIFYING AND DELIVERING VITRIFIED BIOACTIVE AGENTS; and U.S. Provisional Application No. 63/217,458 filed Jul. 1, 2021 and entitled DEVICE FOR VITRIFYING AND DELIVERING VITRIFIED BIOACTIVE AGENTS, both of which are incorporated herein in their entirety by reference.

### TECHNICAL FIELD

The present specification relates to devices for vitrifying and delivering vitrified bioactive agents.

### BACKGROUND

Delivery of biological agents for the treatment of diseases or conditions is most commonly by intravenous (IV) administration. Biological agents are typically considered therapeutic molecules with high molecular weights (e.g. above 500 Da) and/or are molecules that are similar to those normally found in the body (e.g. antibodies). Monoclonal antibodies (mAbs) make up the majority of the biological agents currently approved for IV administration. Representative examples of mAbs approved for IV infusion are numerous and include Muromonab-CD3 for treatment of organ transplant rejection, infliximab for treatment of rheumatoid arthritis among other conditions, rituximab for treatment of non-Hodgkin's lymphomas, and alemtuzamab for treatment of B-cell chronic lymphocytic leukemia, among a large number of other such mAbs. Other biological agents are also well known that currently require IV administration such as, but not limited to aldesleukin for treatment of melanoma, among others. From a practical perspective, antibody therapy frequently requires large therapeutic doses (e.g., 8 mg/kg for trastuzumab; 375 mg/m2 for rituximab), necessitating an injection volume for complete solubilization of the antibody that can only be administered via IV.

One limitation of IV infusion is the potential for rapid clearance of the therapeutic agent. Clearance of biologics from the circulation can occur either by renal filtration or nonspecific binding and uptake (e.g., endothelial pinocytosis). A short circulatory half-life can necessitate frequent injections, from weekly to daily doses, thus increasing the patient's discomfort, overall expense of the treatment regimen, and risks of patient noncompliance.

To increase the plasma half-life, a strategy known as PEGylation has been developed, in which the hydrophilic polymer (polyethylene glycol; “PEG”) is covalently conjugated to the therapeutic. This increases the hydrodynamic size of the therapeutic molecule, thereby reducing its rate of renal clearance and significantly enhancing persistence in the circulation, up to several hundred-fold. However, successful examples of FDA-approved PEGylated biologics for IV administration are limited, e.g., pegloticase (uric acid-metabolizing enzyme) for the treatment of chronic gout.

Other limitations of IV delivery is the potential toxic side effects in non-target organs that can be subjected to high levels of intravenously administered biologic. For example, aldesleukin therapy requires a significantly lower dosage than antibody therapies (0.037 mg/kg per dose), but the systemic infusion of aldesleukin is associated with severe adverse effects that can be potentially fatal, thus requiring inpatient administration. Another recombinant cytokine therapy that has proven extremely difficult to optimize in terms of balancing efficacy with minimal toxicity has been the use of tumor necrosis factor a (TNF-a) as an immunostimulatory anticancer treatment. TNF-a is believed to act preferentially on tumor endothelium, inducing hyperpermeability that results in hemorrhagic necrosis of the tumor tissue. However, systemic exposure to high levels of TNF-a can cause severe toxicities such as hypotension and septic shock-like syndrome.

The problems of toxicity and rapid clearance after the IV delivery of biologics are both related to the near-immediate systemic availability of the infused therapy. Such rapid availability may be necessary to achieve therapeutic efficacy; however, many biologic drugs benefit from a slower pharmacokinetic distribution through the body (while maintaining systemic availability). In addition, IV infusion is accompanied by the risk of catheter-mediated infection, especially with the emergence of resistant spores in hospital environment, causes significant pain and discomfort, and requires supervised inpatient administration.

For more patient-friendly administration and to enable self-administration, subcutaneous (SC) delivery of biologics is of great interest. A number of licensed biologics are currently administered SC, and the success of this route of administration has been critical for biologic therapies used in managing chronic disease states or symptoms, particularly when coupled with delivery to pre-filled syringes (PFS), pens, or auto-injector devices which allow self- and home-administration. In fact, many PEGylated biologics have been approved for SC injection including the recent COVID-19 vaccines from Pfizer and Moderna. Subcutaneous administration both increases patient compliance and avoids hospitalization, thus reducing treatment costs. Particularly for biologic drugs with short circulatory half-lives that may require frequent dosing, the ability to self-administer therapy via SC injection, as opposed to requiring the continual inpatient administration of IV infusions, provides an enormous benefit to patient quality of life.

Another context in which the use of SC injection is able to improve on IV delivery is in the case of biologic drugs with severe toxicity after systemic infusion. For example, recombinant cytokine therapies such as a and b INFs can provide therapeutic benefits in a number of diseases, including various cancers, hepatitis B and C, and multiple sclerosis, but the IV delivery of such therapies can lead to adverse events after rapid systemic dissemination of the therapeutic. SC administration provides an advantage over IV infusion by creating a relative depot effect at the site of injection: the time required for the therapeutic to drain into systemic circulation effectively prolongs the half-life of the agent in vivo while simultaneously lowering the peak drug level experienced by various compartments, thus reducing the frequency of dosing required as well as reducing the frequency or severity of adverse events.

Although SC injections can be used to achieve a flatter pharmacokinetic profile (a lower peak plasma concentration but a more prolonged duration at an efficacious level), a limitation of the SC route is the injection volume that can be administered without pain, which in humans is typically a maximum of approximately 2 to 2.5 ml of fluid. For regimens of some biologics, such as therapeutic antibodies in oncology applications, the most concentrated form of the drug that can be prepared in a stable, injectable form requires a dosing volume of 5 ml, making traditional SC injection problematic. To overcome this volume limitation, one strategy currently in clinical trials is the use of recombinant human hyaluronidase to locally digest hyaluronic acid, a key polysaccharide component of the extracellular matrix (ECM) in connective tissues.

When hyaluronidase is co-injected with biologics, it generates nanoscale porosity in the local ECM allowing rapid draining of fluid from the injection site and permitting larger volumes of solution to be injected without pain; the matrix self-repairs within about 24 hours, making the alterations only transient. Several approved mAbs in oncology (trastuzumab, rituximab) that are currently given as IV infusions are being tested with this modified administration strategy to improve patient compliance with prolonged (>1 year) maintenance therapies that are indicated in conditions such as early breast cancer treatment.

Another motivation for the local injection of biologic drugs is to minimize systemic exposure and the subsequent toxicities that may result. An example of this is the intravitreal injection (directly into the eye) of vascular endothelial growth factor (VEGF) antagonists for the treatment of age-related macular degeneration (AMD). Pegaptinib, an RNA aptamer that targets VEGF, and the anti-VEGF mAbs bevacizumab and ranibizumab have all demonstrated the ability to slow the progression of AMD. However, the systemic infusion of VEGF antagonists can potentially disrupt the normal functions of VEGF in healthy vasculature throughout the body, leading to increased risks of thromboembolic events, hypertension, and impaired wound healing. Early clinical studies showed that intravitreal injections of VEGF antagonists had an improved safety profile compared with IV infusion, with reduced frequency of systemic adverse events.

Another important motivation for the local injection of biologic therapy is to maximize the local concentration of therapy, improving the efficacy of treatment on a specific tissue or organ. For example, the bispecific antibody catumaxomab (anti-CD3/anti-epithelial cell adhesion molecule EPCAM) is injected intraperitoneally for the treatment of malignant ascites resulting from epithelial, gastric, or ovarian cancers. Preclinical pharmacokinetic studies confirmed that intraperitoneal (IP) administration of catumaxomab produced high local concentrations of the antibody in the ascites fluid while significantly limiting systemic exposure (<5% detectable in plasma), a critical finding given the potential toxicity of systemic anti-CD3 stimulation.

To exploit the aforementioned benefits of SC administration, high concentration solutions are needed to keep the injected volume low. High-concentration protein formulations (HCPF)—is generally, but imprecisely, applied to preparations ranging between 50 and 150 mg/ml protein, but the physical characteristics of HCPF can be applied to non-protein biologics as well. Characteristics of HCPFs include, for example, increased viscosities, high opalescence, liquid-liquid phase separation, gel formation, or the increased propensity for protein particle formation. Principal goals for the high concentration formulations are protein-stability and good injectability, where the latter requires low-to-moderate viscosity. Mechanisms of chemical degradation include deamidation, oxidation, and iso-asparte formation. Insufficient colloidal stability leads to irreversible aggregation, precipitation and phase separation.

Although limited, commercialized high-concentration biologics, with protein concentrations between 150 and 200 mg/mL, are supplied as lyophilized (freeze dried) products. However, for the development of high-concentration, freeze-dried protein formulations, additional challenges appear, such as extremely prolonged reconstitution times and stability issues. Some of the properties observed at high protein concentration impose particular challenges for developing a lyophilized drug product.

Colloidal instability increases at higher protein concentrations. Liquid-liquid phase separation can be enhanced during the freezing step of lyophilization. Phase separation of excipients during lyophilization can also impair protein stability. Excipient phase-separation may be one of the reasons that the “glassy immobilization” concept, often used to explain protein stabilization in lyophilized solids, does not always hold. That is, the protein simply does not “see” the glass. An excipient acting as an effective protein stabilizer not only forms a chemically inert glass, but also “forms a single phase with the protein, which requires a ‘moderate’ interaction with the protein surface to resist separation but yet not denature the protein.” Pikal, M. J. Freeze-drying of proteins. In Stability, Formulation and Delivery of Peptides and Proteins; Cleland, J. L.; Langer, R., Eds., ACS Symposium Series, American Chemical Society: Washington, D.C., 1994; pp 120-133. An excipient that remains hydrogen bonded to the protein during drying cannot be phase-separated from the protein.

The protein's behavior during freezing is another important aspect of lyophilization. At high concentrations (˜50 mg/ml), freezing can increase opalescence accompanied by the formation of visible particles and a decrease in monomer content. Chemical degradation, namely glycation has been associated with freezing process. With increasing protein concentration, the difference between the glass transition and collapse temperature becomes progressively larger. It has been observed that reconstitution times of freeze-dried HCPF are extremely prolonged, up to 30 min and longer.

In summary, high concentration is often a consequence of clinicians' demands for high bioactive agent doses within a limited injection volume. This is not an ideal starting point for developing an efficient freeze-drying cycle. High concentration and high density of solids hinder water-vapor transport and result in longer drying times. There is also the correlation between protein concentration in the lyophilizate and increasing reconstitution time.

New structures are needed for vitrifying, storing, shipping, reconstituting and/or delivering high concentration biologic therapeutic agents to improve efficacy and address needs for patient compliance and comfort.

### SUMMARY

In embodiments, a device for vitrifying bioactive agents and delivering vitrified bioactive agents is provided. The device includes a top housing having an inner surface, an outer surface, and a perimeter. A bottom housing has an inner surface, an outer surface, and a perimeter. An interconnect structure is operable to interconnect the top housing and the bottom housing to define an interior volume between the inner surface of the top housing and the inner surface of the bottom housing. The bottom housing is formed of a flexible material such that the bottom housing is deformable between a first configuration wherein the bottom housing is curved away from the top housing, and a second configuration wherein the bottom housing is curved toward the top housing.

In another embodiment, a device for vitrifying bioactive agents and delivering vitrified bioactive agents is provided. The device includes a top housing having an inner surface, an outer surface, and a perimeter. A bottom housing has an inner surface, an outer surface, and a perimeter. An interconnect structure is operable to interconnect the top housing and bottom housing to define an interior volume between the inner surface of the top housing and the inner surface of the bottom housing. The interconnect structure is operable to interconnect the top housing and the bottom housing in a first position wherein the inner surface of the top housing and the inner surface of the bottom housing are spaced apart by a first distance, and in a second position wherein the inner surface of the top housing and the inner surface of the bottom housing are spaced apart by a second distance that is less than the first distance.

In yet another embodiment, a method for vitrifying bioactive agents and/or delivering vitrified bioactive agents is provided. The method includes providing a device for delivering vitrified bioactive agents including: a top housing having an inner surface, an outer surface, and a perimeter; a bottom housing having an inner surface, an outer surface, and a perimeter; the top and bottom housing being interconnected to define an interior volume between the inner surface of the top housing and the inner surface of the bottom housing; and a substrate disposed in the interior volume, the substrate including or supporting a vitrified bioactive agent. The method further includes introducing an administration solvent into the interior volume of the device and reconstituting the bioactive agent into the administration solvent.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a perspective view of a device, according to one or more embodiments shown and described herein;

FIG. 2 depicts a cross sectional perspective view of the device of FIG. 1, according to one or more embodiments shown and described herein;

FIG. 3 depicts a side view of the device of FIG. 1, according to one or more embodiments shown and described herein;

FIG. 4 depicts a cross sectional side view of the device of FIG. 1, according to one or more embodiments shown and described herein;

FIG. 5 depicts a perspective view of the device of FIG. 1 in a sealed configuration, according to one or more embodiments shown and described herein;

FIG. 6 depicts a cross sectional perspective view of the device of FIG. 1 in the sealed configuration, according to one or more embodiments shown and described herein;

FIG. 7 depicts a side view of the device of FIG. 1 in the sealed configuration, according to one or more embodiments shown and described herein;

FIG. 8 depicts a cross sectional side view of the device of FIG. 1 in the sealed configuration, according to one or more embodiments shown and described herein;

FIG. 9 depicts a perspective view of the device of FIG. 1 in a storage or shipping configuration, according to one or more embodiments shown and described herein;

FIG. 10 depicts a cross sectional perspective view of the device of FIG. 1 in the storage or shipping configuration, according to one or more embodiments shown and described herein;

FIG. 11 depicts a side view of the device of FIG. 1 in the storage or shipping configuration, according to one or more embodiments shown and described herein;

FIG. 12 depicts a cross sectional side view of the device of FIG. 1 in the storage or shipping configuration, according to one or more embodiments shown and described herein;

FIG. 13 depicts a perspective view of the device of FIG. 1 in a storage or shipping configuration with a seal, according to one or more embodiments shown and described herein;

FIG. 14 depicts a cross sectional side view of the device of FIG. 1 in the storage or shipping configuration with a seal, according to one or more embodiments shown and described herein;

FIG. 15 depicts a perspective view of the device of FIG. 1 during reconstitution of the vitrified bioactive agent for use, according to one or more embodiments shown and described herein;

FIG. 16 depicts a cross sectional perspective view of the device of FIG. 1 during reconstitution of the vitrified bioactive agent for use, according to one or more embodiments shown and described herein;

FIG. 17 depicts a side view of the device of FIG. 1 during reconstitution of the vitrified bioactive agent for use, according to one or more embodiments shown and described herein;

FIG. 18 depicts a cross sectional side view of the device of FIG. 1 during reconstitution of the vitrified bioactive agent for use, according to one or more embodiments shown and described herein;

FIG. 19 depicts a perspective view of the device of FIG. 1 during withdrawal of the vitrified bioactive agent, according to one or more embodiments shown and described herein;

FIG. 20 depicts a cross sectional perspective view of the device of FIG. 1 during withdrawal of the vitrified bioactive agent, according to one or more embodiments shown and described herein;

FIG. 21 depicts a side view of the device of FIG. 1 during withdrawal of the vitrified bioactive agent, according to one or more embodiments shown and described herein;

FIG. 22 depicts a cross sectional side view of the device of FIG. 1 during withdrawal of the vitrified bioactive agent, according to one or more embodiments shown and described herein;

FIG. 23 depicts a perspective view of a device without a bent connector, according to one or more embodiments shown and described herein;

FIG. 24 depicts a perspective view of a device of with a bent connector, according to one or more embodiments shown and described herein;

FIG. 25 depicts a cross sectional perspective view of the device of FIG. 24 with the bent connector, according to one or more embodiments shown and described herein;

FIG. 26 depicts a perspective view of the device of FIG. 24 during reconstitution of the vitrified bioactive agent for use, according to one or more embodiments shown and described herein;

FIG. 27 depicts a cross sectional perspective view of the device of FIG. 24 during reconstitution of the vitrified bioactive agent for use, according to one or more embodiments shown and described herein;

FIG. 28 depicts a side view of the device of FIG. 24 during reconstitution of the vitrified bioactive agent for use, according to one or more embodiments shown and described herein;

FIG. 29 depicts a cross sectional side view of the device of FIG. 24 during reconstitution of the vitrified bioactive agent for use, according to one or more embodiments shown and described herein;

FIG. 30 depicts a set of photos showing a bottom housing of a device prototype collapsing and expanding during use, according to one or more embodiments shown and described herein;

FIG. 31 depicts a photo showing components of device prototypes during temperature testing, according to one or more embodiments shown and described herein;

FIG. 32 depicts a graph providing a comparison between the temperature of the membrane substrate during vitrification inside the prototype device, according to one or more embodiments shown and described herein, and inside a glass vial that is industrially used for liquid/lyophilized drugs storage and distribution;

FIG. 33 depicts a flowchart of steps for testing a device, according to one or more embodiments shown and described herein;

FIG. 34 depicts resulting data of the testing in FIG. 33, according to one or more embodiments shown and described herein;

FIG. 35 depicts a flow chart of steps for functional analysis, according to one or more embodiments shown and described herein;

FIG. 36 depicts resulting data of the functional analysis of FIG. 35, according to one or more embodiments shown and described herein;

FIG. 37 depicts a graph showing Luciferase stabilization data comparing the device according to one or more embodiments shown and described herein and a commercial product;

FIG. 38 depicts a perspective view of a device, according to one or more embodiments shown and described herein;

FIG. 39 depicts a perspective exploded view of the device of FIG. 38, according to one or more embodiments shown and described herein;

FIG. 40 depicts a side exploded view of the device of FIG. 38, according to one or more embodiments shown and described herein;

FIG. 41 depicts a side view of the device of FIG. 38, according to one or more embodiments shown and described herein;

FIG. 42 depicts a perspective view of a top housing of the device of FIG. 38, according to one or more embodiments shown and described herein;

FIG. 43 depicts a perspective view of a bottom housing of the device of FIG. 38, according to one or more embodiments shown and described herein;

FIG. 44 depicts a cross sectional side view of the device of FIG. 38 with the top housing resting on the bottom housing, according to one or more embodiments shown and described herein;

FIG. 45 depicts a cross sectional side view of the device of FIG. 38 in a first position, according to one or more embodiments shown and described herein;

FIG. 46 shows a cross sectional side view of the device of FIG. 38 in a second position, according to one or more embodiments shown and described herein;

FIG. 47 provides a perspective view and cross sectional side views of the device of FIG. 38 with a needle assembly and a syringe, according to one or more embodiments shown and described herein;

FIG. 48 depicts a graph showing Luciferase stabilization data comparing the device of FIG. 38 according to one or more embodiments shown and described herein and a commercial product;

FIG. 49 depicts data and a graph showing elution efficiency of Luciferase vitrified comparing the device according to one or more embodiments shown and described herein and a commercial product;

FIG. 50 depicts a perspective view of an assembled device with portions being partially transparent, according to one or more embodiments shown and described herein;

FIG. 51 depicts a cross sectional perspective view of the device of FIG. 50, according to one or more embodiments shown and described herein;

FIG. 52 depicts a cross sectional side view of the device of FIG. 50, according to one or more embodiments shown and described herein;

FIG. 53 depicts a cross sectional side view of the device of FIG. 50, where a top housing is moved toward a bottom housing, according to one or more embodiments shown and described herein;

FIG. 54 depicts a cross sectional perspective view of the device of FIG. 50, where a top housing is moved toward a bottom housing, according to one or more embodiments shown and described herein;

FIG. 55 depicts a cross sectional side view of the device of FIG. 50 during reconstitution of the bioactive agent, according to one or more embodiments shown and described herein; and

FIG. 55 depicts a cross sectional perspective view of the device of FIG. 50 during reconstitution of the bioactive agent, according to one or more embodiments shown and described herein.

Reference will now be made in greater detail to various embodiments of the present disclosure, some embodiments of which are illustrated in the accompanying drawings. Whenever possible, the same reference numerals will be used throughout the drawings to refer to the same or similar parts.

### DETAILED DESCRIPTION

The present disclosure provides embodiments of devices, which may be used for vitrification of bioactive agents, storage and/or shipping of the vitrified bioactive agents, and reconstitution of the vitrified bioactive agents for delivery as a concentrated bioactive agent. The embodiments may also be used for only one of these steps, such as for reconstitution but not for vitrification, or for a subset of steps such as shipping and reconstitution but not vitrification.

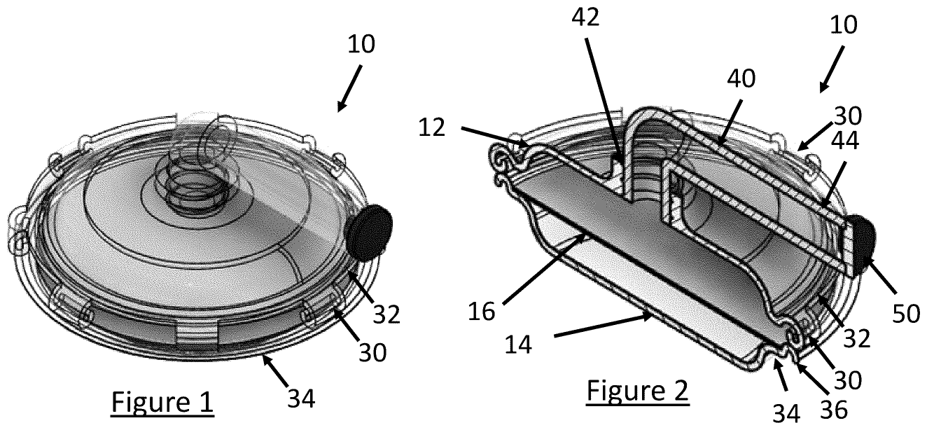

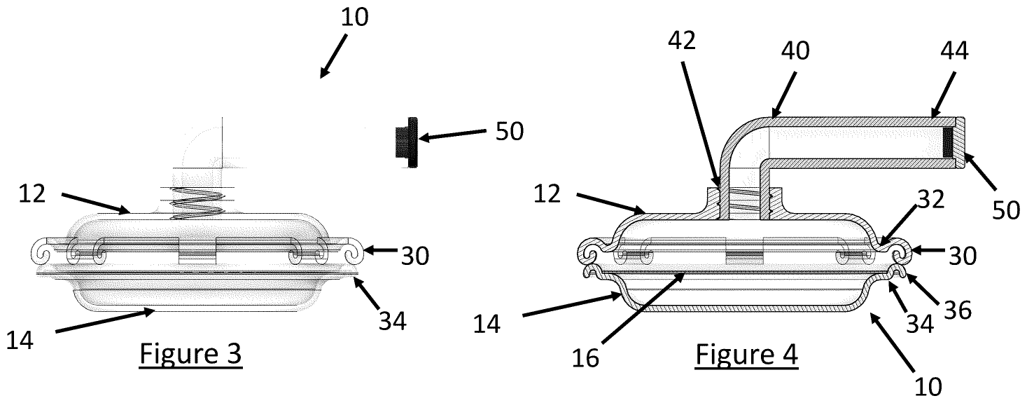

FIGS. 1-4 show an embodiment of a device in accordance with the present disclosure in a vitrification configuration, in which a substrate may be exposed to vacuum or otherwise vitrified. FIG. 1 is a perspective view of a device 10 according to an embodiment of the present disclosure, in the vitrification configuration, with some portions shown as partially transparent for clarity of structure. FIG. 2 is a cross sectional perspective view of the device 10. FIG. 3 is a side view of the device 10 and FIG. 4 is a cross sectional side view of the device 10.

The device 10 includes a top housing 12 defining an upper end of the device and a bottom housing 14 defining a lower end of the device, with the top and bottom housings configured to engage with one another to form the assembled device. It is noted that positions terms such as “upper”, “lower”, “top” and “bottom” are used herein to assist in describing an embodiment of the present disclosure but are not limiting. The device may be inverted or positioned differently than shown.

The top housing 12 has a concave lower surface facing a concave upper surface of the bottom housing, such that an interior volume is defined between the concave surfaces of the housings. The top housing 12 further has a connector 40 providing a fluid connection to interior volume. In the illustrated embodiment, the connector 40 connects to a central port 42 in the top housing, extends upwardly to a right angle bend, and then outwardly to a tip 44. During vitrification, the connector may be open or closed. In the illustrated embodiment, a plug or seal 50 closes the tip.

As best shown in FIGS. 2 and 4, the device 10 further includes a substrate 16, which may contain or support a vitrified bioactive agent. The substrate may be a membrane scaffold or any other structure operable to function within the disclosure. Alternatively, the substrate may be separately provided and not be considered part of the device. In this example, the substrate is supported on the bottom housing such that it is disposed in the interior volume of the device 10.

The device 10 further includes an interconnect structure that is operable to interconnect the top and bottom housings. In the illustrated embodiment, the top and bottom housings 12, 14 are each generally circular with a generally circular outer perimeter, but other shapes such as rectangular or triangular are possible. In this example, the outer perimeters have approximately the same diameter. In this embodiment, the interconnect structure includes a plurality of lock elements 30, extending from the outer perimeter 32 of the top housing 12, that selectively engage the outer perimeter of the bottom housing 14. In the vitrification configuration of FIGS. 1-4, the lock elements 30 rest atop the outer perimeter 34 of the bottom housing thereby providing a space between the top and bottom housings such that gas may freely flow between the interior volume and the surrounding area.

In this example, the outer perimeter 34 of the bottom housing 14 has a downwardly turned lip 36 and the lock elements 30 are curved downwardly and inwardly so as to engage this lip 36 in a further configuration discussed hereinbelow.

The interconnect structure may take other forms, including one or more elements separate from the top and bottom housings and operable to interconnect the housings.

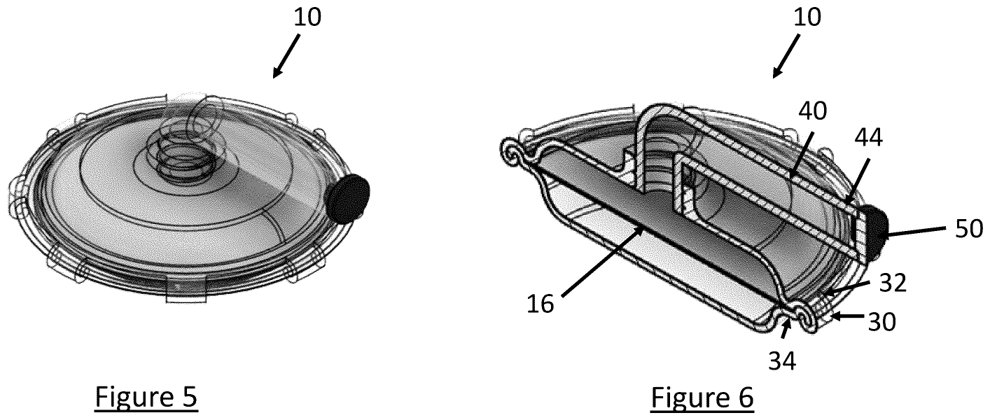

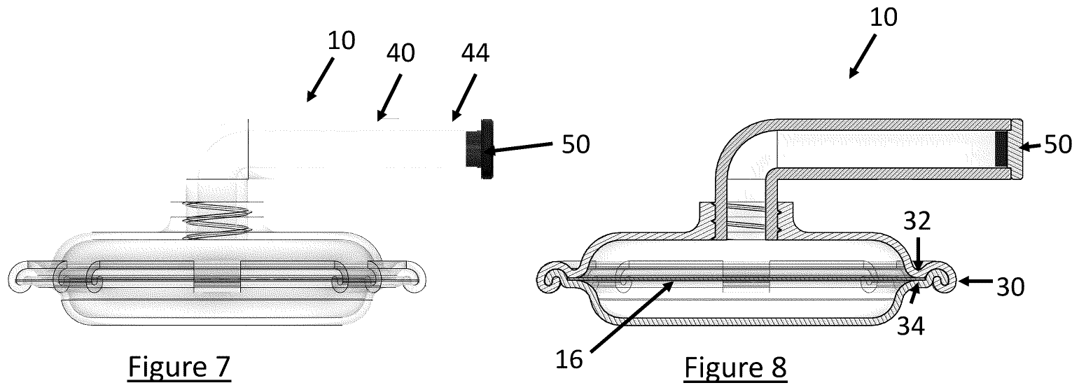

With the device 10 in the vitrification configuration of FIGS. 1-4, the bioactive agent on the substrate may be vitrified, typically under a vacuum. Vitrification of bioactive agents by dehydration in the presence of glass forming sugar trehalose has been disclosed in U.S. Pat. No. 10,433,540 and U.S. Provisional Application No. 63/115,936, now PCT application WO/2022/109315. The device is then moved into a sealed configuration by moving the top housing towards the bottom housing until the interconnect structure interconnects the top housing to the bottom housing. FIGS. 5-8 show the device 10 in this configuration, wherein the perimeter 32 of the top housing is sealed to the perimeter 34 of the bottom housing by the lock elements 30. As best shown in FIG. 8, the substrate 16 may be trapped and held between the perimeters. A seal or sealing material, such as an adhesive material, may be provided between the perimeters to enhance the seal. Alternatively or additionally, the materials forming the top and bottom housings is chosen so as to seal to one another.

In some embodiments, the top and bottom housings are both formed of a polymer, though other materials may be used.

In the sealed configuration of FIGS. 5-8, the device 10 may be in a vacuum environment, following vitrification. The plug or seal 50 remains in the tip 44 of the connector 40. Alternatively, the plug or seal 50 may be added after vitrification but while the vacuum remains. At this point, the interior volume of the device 10 contains a vacuum both above and below the substrate 16.

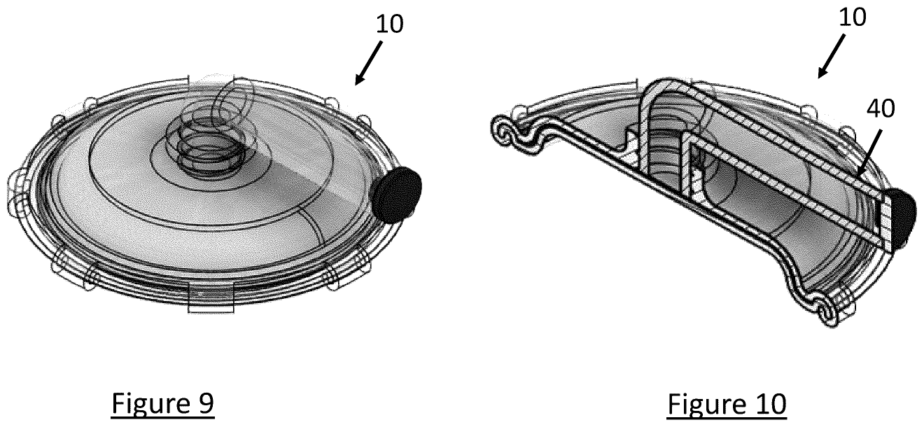

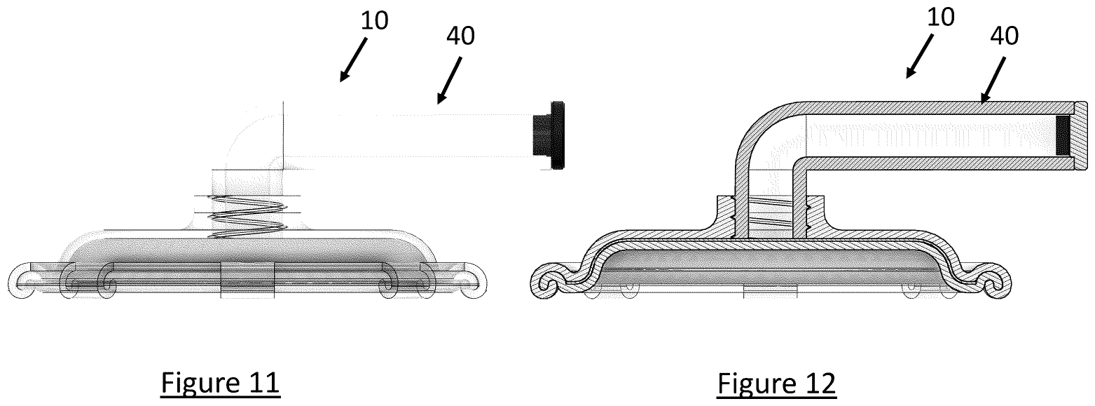

Referring now to FIGS. 9-12, the device 10 is shown in a storage or shipping configuration. In this configuration, the vacuum surrounding the device is released, thereby applying atmospheric pressure to the outside of the top and bottom housings 12, 14. The bottom housing 14 is formed of a material that is sufficiently flexible that the bottom housing flexes upwardly until the interior volume is minimized and the substrate is held between the inner surfaces of the top and bottom housings 12, 14. In this configuration, the bottom housing 14 flips from having a concave inner surface to having a convex inner surface. In the illustrated embodiment, the top and bottom housings 12, 14 are shaped such that the flipped or inverted bottom housing has an inner surface that is coextensive with the inner surface of top housing 12, thereby nearly minimizing the interior volume of the device 10. The majority of the remaining empty volume is in the connector 40.

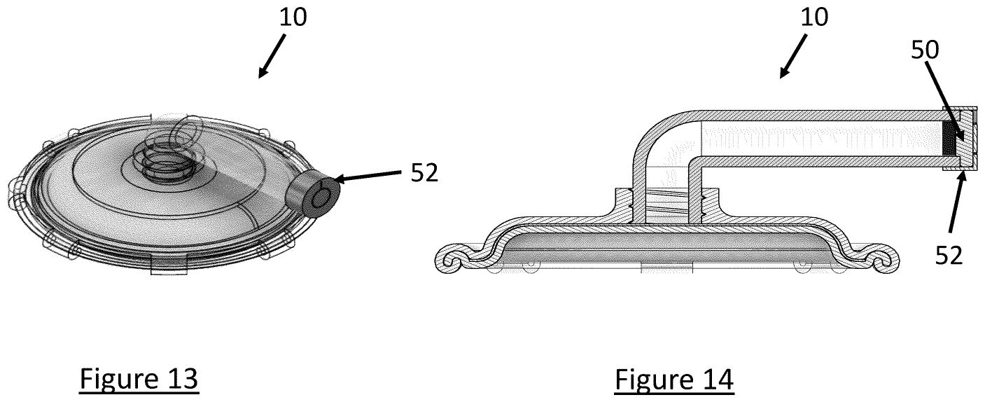

FIGS. 13 and 14 illustrate that the device in the storage/shipping configuration may further have a seal 52, such as a metal seal, installed on the plug 50 so as to protect the plug 50 during shipping and storage. It may also or additionally have another moisture barrier seal like common lyophilized vials.

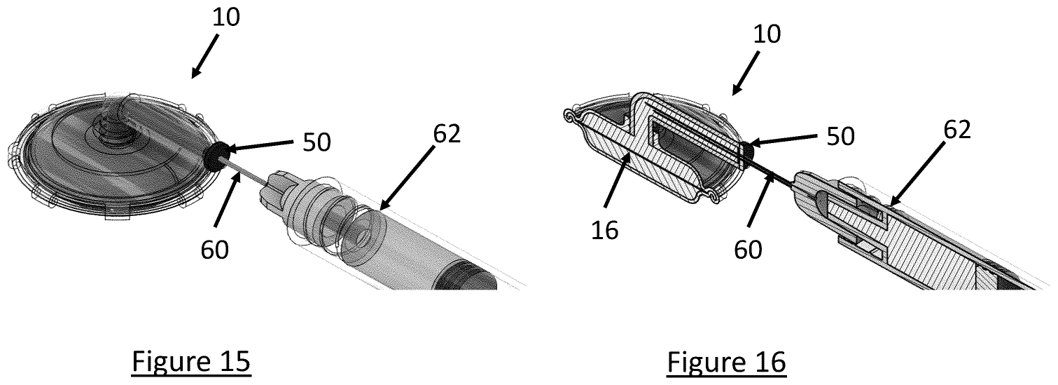

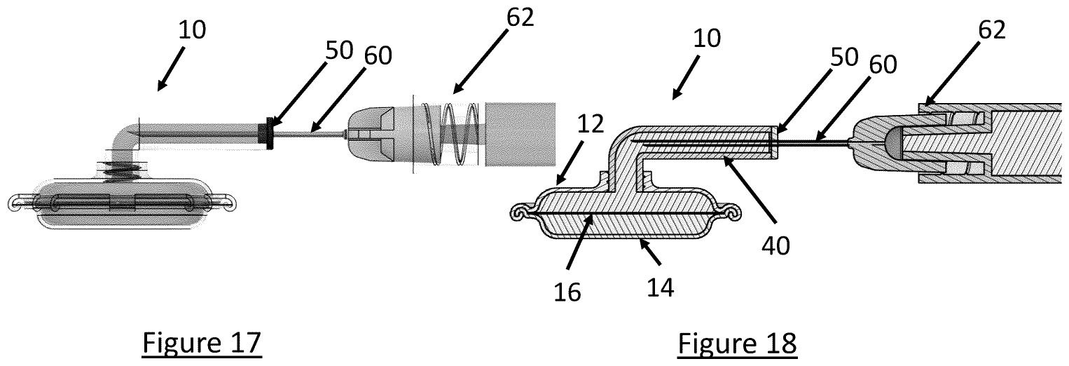

FIGS. 15-18 illustrate reconstitution of the vitrified bioactive agent for use. The seal 52 (e.g., a cap, a metal cap, or the like) may be removed so as to expose the plug 50 and a needle 60 of a syringe 62 is inserted through the plug 50 into the connector 40, or the seal 52 may be thin enough to be punctured by the syringe without the need to remove the seal 52. An administration solvent is injected into the device 10. The administration solvent may be suitable for administration to an organism, optionally a human. The interior volume of the device 10 expands as the administration solvent is added. The vacuum present in the connector 40 may assist in drawing the administration solvent into the connector 40. As further administration solvent is added, the bottom housing 14 moves away from the top housing 12 and the administration solvent fills the space above the substrate 16. Further, the administration solvent moves through the substrate and fills the space below the substrate until the inner surface of the bottom housing 14 has been restored to its concave shape, similar to when the device 10 was in the vitrification configuration. The bioactive agent is then reconstituted into the administration solvent and becomes ready for use. The reconstitution process may involve additional steps such as moderate mechanical agitation.

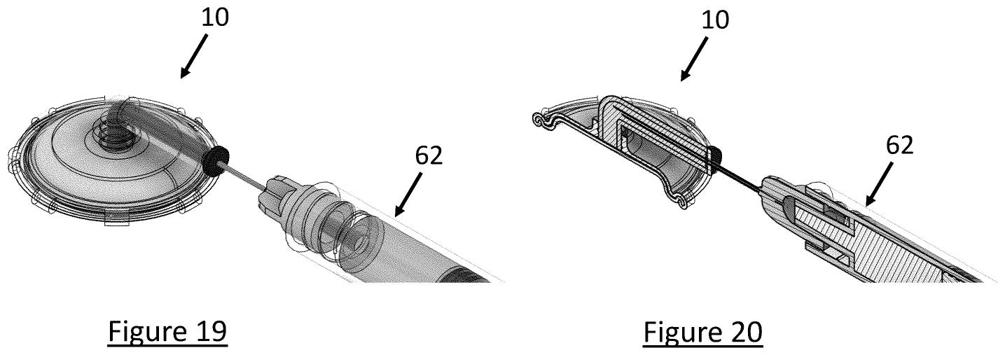

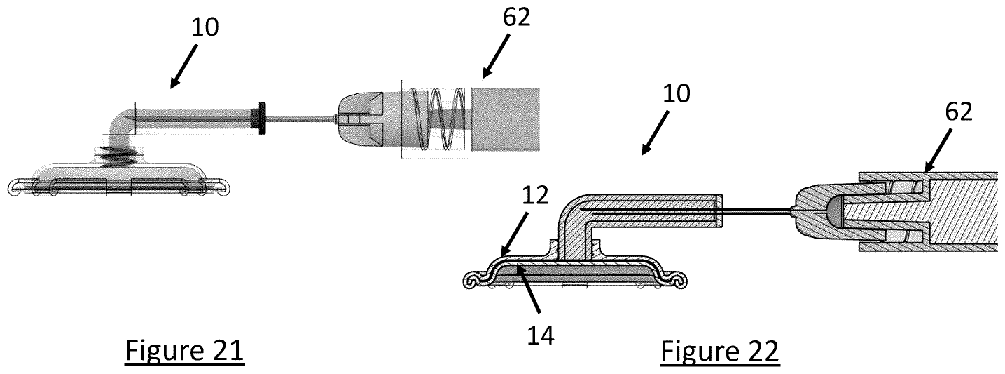

FIGS. 19-22 illustrate that the administration solvent, with the reconstituted bioactive agent, is then withdrawn into a syringe 62, which may be the same syringe 62 as used in the reconstitution step or may be a fresh syringe. As the administration solvent is withdrawn, the suction causes the bottom housing 14 to again move to the inverted position wherein the inner surface is convex and coextensive with the inner surface of the top housing 12. As shown, the interior volume is minimized such that nearly all of the administration solvent with the bioactive agent is withdrawn into the syringe 62. The administration solvent with the bioactive agent may then be administered to a patient.

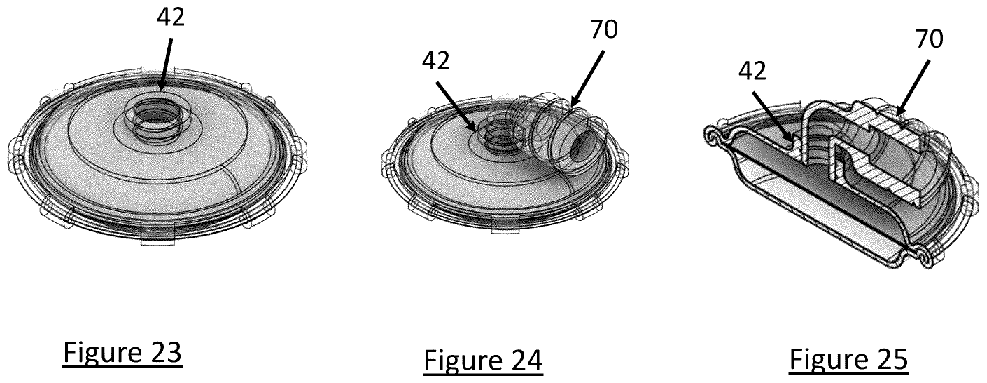

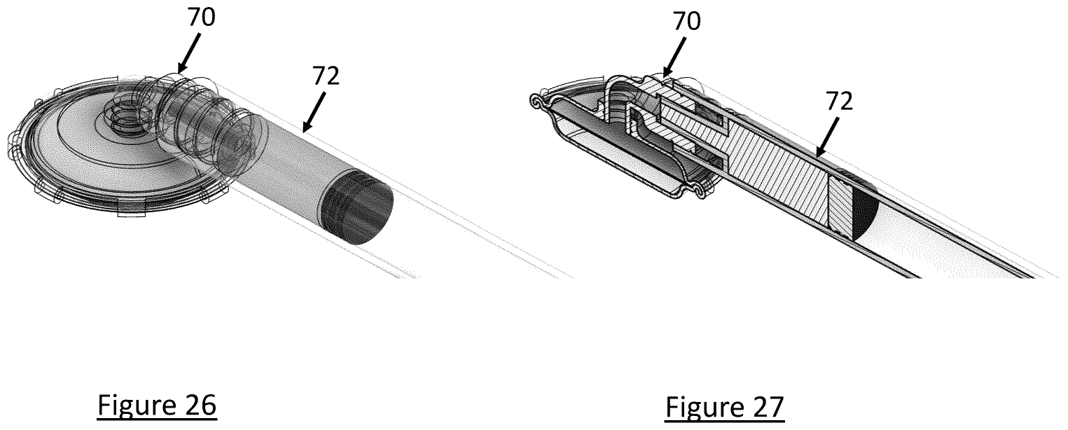

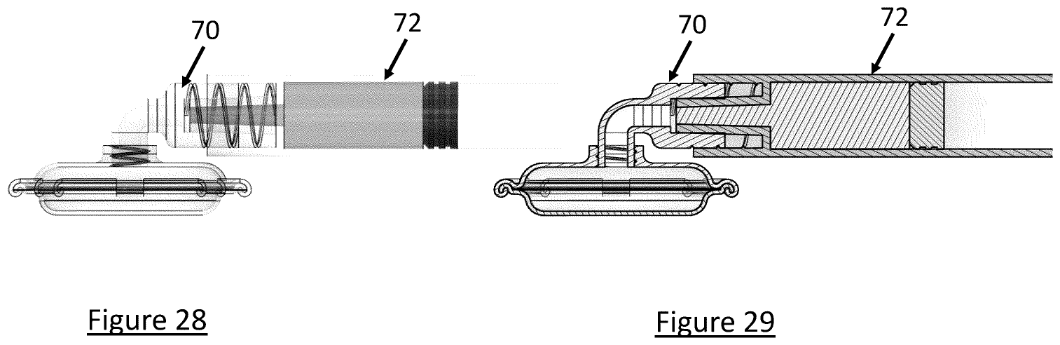

FIGS. 23-29 illustrate that other connectors may be used with the device 10. FIG. 23 shows the central port 42 without a bent connector 70. The central port 42 may be directly utilized for reconstitution and withdrawal, with a plug or seal being provided in the central port 42. FIGS. 24 and 25 illustrate a connector 70 configured for direct connection to the body of a syringe 72, without the need for a needle. FIGS. 26-29 show the same connector 70 with a syringe body 72 attached. The device may be stored and shipped with the syringe body attached or the body may be attached for the reconstitution step. Other connectors may also be used.

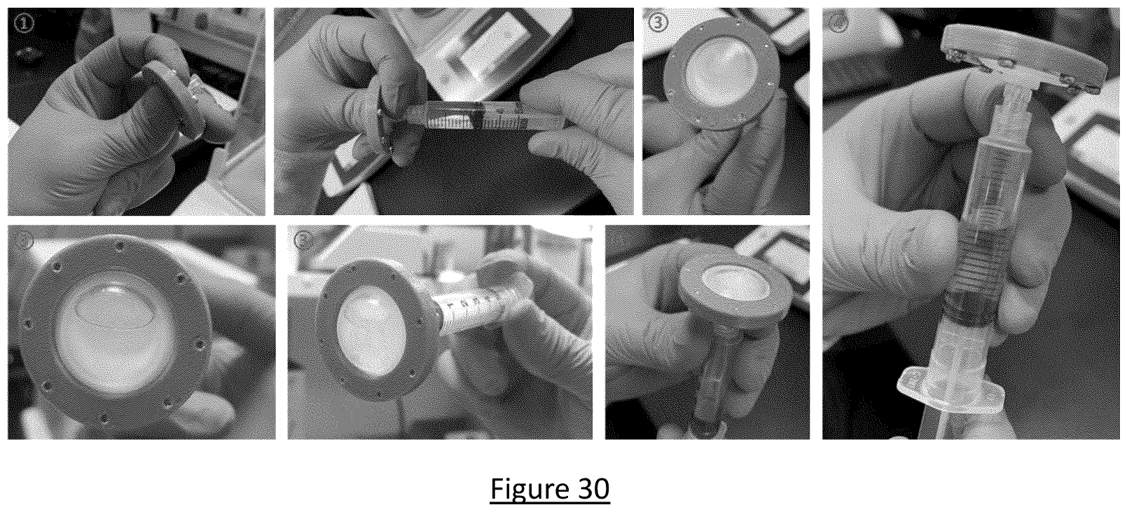

FIG. 30 is a set of photos showing a prototype of the device discussed above, demonstrating how the bottom housing collapses and expands during use.

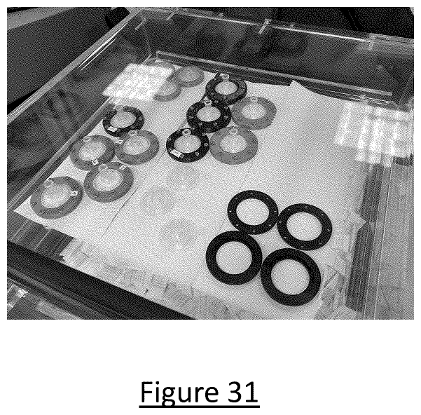

FIG. 31 is a photo showing components of the prototypes during temperature testing.

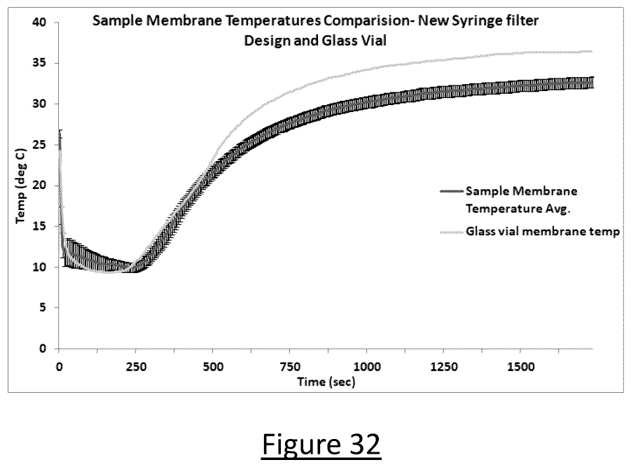

FIG. 32 is a graph providing a comparison between the temperature of the membrane substrate during vitrification inside the prototype device according to the present disclosure and inside a glass vial that is industrially used for liquid/lyophilized drugs storage and distribution. The temperature rise in the case of glass vial is slightly faster than the prototype device due to conductivity differences in material.

Testing demonstrated the following values for residual moisture and residual volume of the prototypes shown in Table 1.

TABLE 1

| Preliminary Tests | Residual Moisture - TGA | Residual/Dead Volume |
|---|---|---|
| Values | 3.02 ± 0.16% | 84.33 ± 10.08 μL |

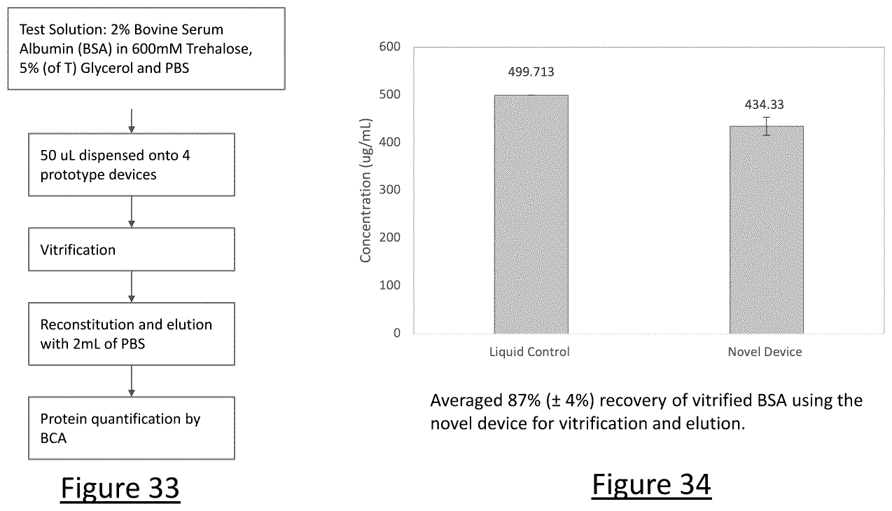

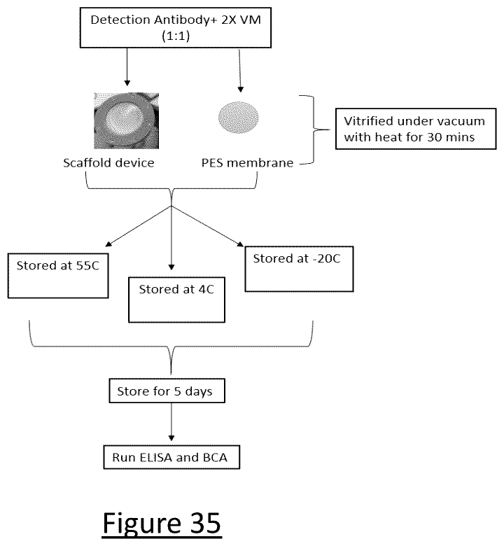

Testing was also performed to determine the elution efficiency of the prototype devices. FIG. 33 is a flowchart of the steps in this test. A test administration solvent with a bioactive agent was dispensed into four prototype devices in the vitrification configuration and vitrification was performed. The bioactive agent was then reconstituted and the bioactive agent was quantified. FIG. 34 provides the resulting data, showing that 87 percent of the bioactive agent was recovered.

A further functional analysis was performed, and illustrated by the flowchart of FIG. 34. A bioactive agent was deposited onto the substrate of sample prototype devices (labeled “scaffold device”) and onto controls (labeled PES membrane) and samples of each were vitrified under vacuum with heat for 30 minutes. Vitrification of bioactive agents by dehydration in the presence of glass forming sugar trehalose has been disclosed in U.S. Pat. No. 10,433,540 and U.S. Provisional Application No. 63/115,936, now PCT application WO/2022/109315. Samples of each were then stored at 55° C., 4° C., and −20° C. for 5 days, then the samples were analyzed.

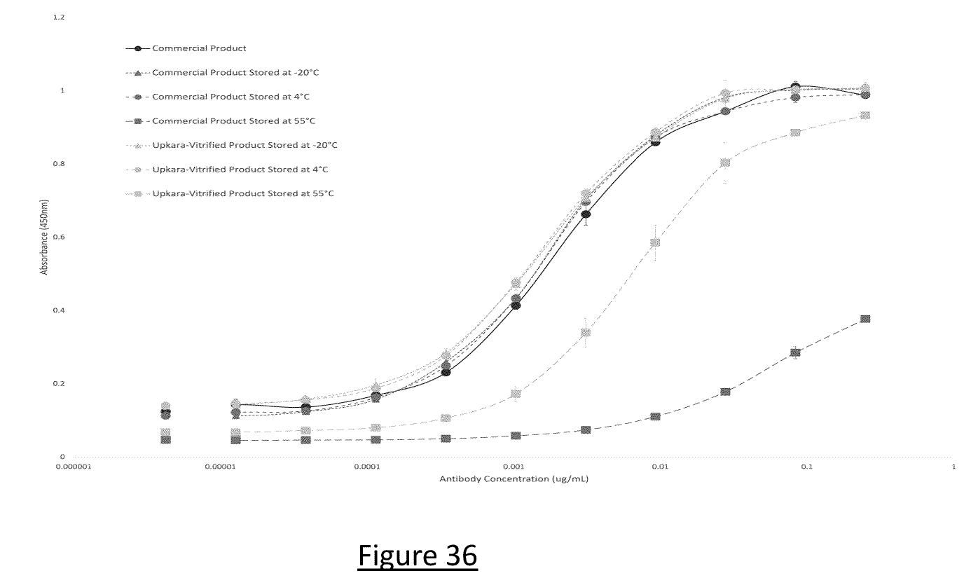

FIG. 36 provides the test results. As shown, an anti-IgG detection antibody conjugated to HRP was stored at −20° ° C., 4° C. or 55° C. in either it's commercial product (liquid) state or vitrified in the prototype device for 5 days. The eluted protein was quantified and normalized using BCA. The antibody was then used as a detection antibody in an ELISA targeting IgG.

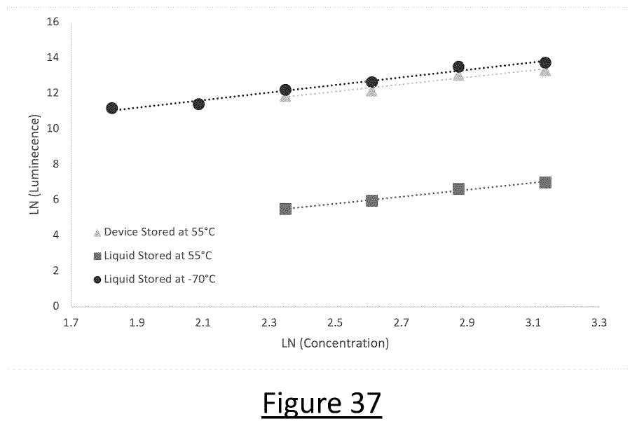

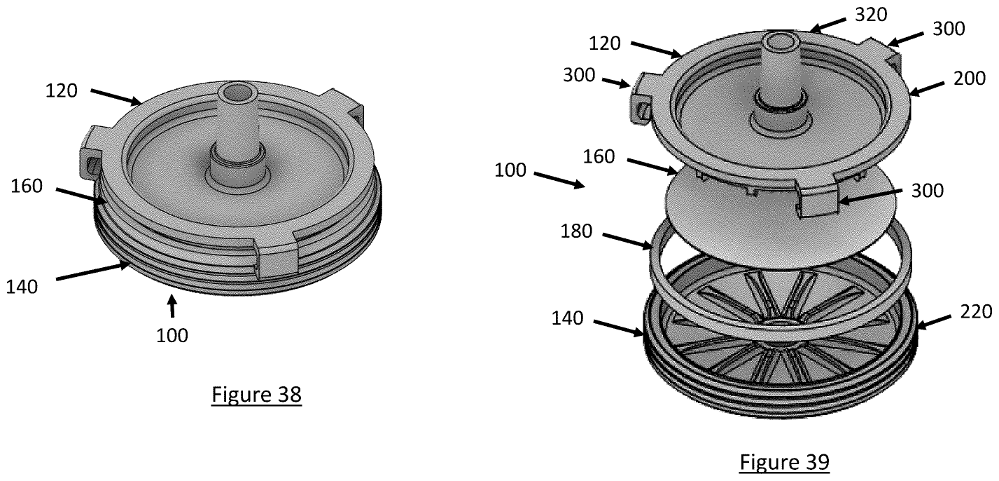

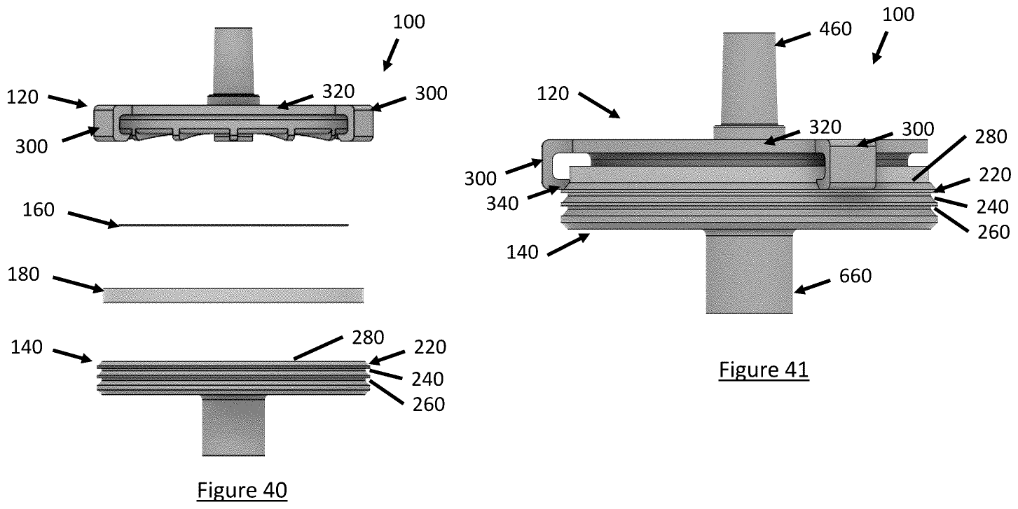

FIG. 37 is a graph showing Luciferase stabilization data and comparing a commercial product stored at a typical −70° C., the commercial product stored at 55° C. for one hour, and with Luciferase vitrified and stored at 55° C. using an apparatus and process as discussed above. As shown, the Luciferase vitrified and stored using the present apparatus and process performs nearly identically to the commercial product stored at −70° ° C. while the commercial product stored at 55° C. for an hour performs less well. The data in the graph was obtained as follows. For vitrification, 50 uL of luciferase in vitrification matrix was added to two devices as disclosed herein. The material added included 1.6 ug/uL luciferase, 600 mM Trehalose and 2.27% glycerol. This was vitrified at 37° C. for 30 minutes in a vacuum chamber. The samples were stored overnight at 55° C. As a heat-stressed liquid control, luciferase stock was diluted to 40 ug/mL in PBS (Phosphate-Buffered Saline) and stored at 55° C. {“Liquid Stored at 55° C.”). For reconstitution, 2 mL of PBS was injected into a device as described herein, and then withdrawn from the device. For the assay, a prepared reagent solution (0.5 mM ATP, 4.5 mM MgSO4, 1.5 mM Luciferin in 25 mM EPPS) was used. A fresh control was prepared by diluting stock luciferase to 40 ug/mL in PBS (“Liquid Stored at −70° C.”). A dilution series was prepared of the three sample types. 50 uL of luciferase dilutions and 50 uL of reagent was added to wells of a 96-well black plate, the samples were incubated at room temperature for 10 minutes, and luminescence was detected.

FIG. 38 shows a device 100 according to an embodiment of the present disclosure, in an assembled configuration. FIGS. 39 and 40 show the device 100 with the constituent elements separates for clarity, with FIG. 39 being a perspective exploded view and FIG. 40 being a side exploded view. The device includes a top housing 120 defining an upper end of the device and a bottom housing 140 defining a lower end of the device 100, with the top and bottom housings 120, 140 configured to engage with one another to form the assembled device. It is noted that positions terms such as “upper”, “lower”, “top” and “bottom” are used herein to assist in describing an embodiment of the present invention but are not limiting. The device may be inverted or positioned differently than shown.

As best shown in FIGS. 39 and 40, the device 100 further includes a substrate 160, which may contain a vitrified bioactive agent. The substrate 160 may be a membrane scaffold or any other structure operable to function within the disclosure. Alternatively, the substrate 160 may be separately provided and not be considered part of the device 100.

Referring again to FIGS. 38-40, the device 100 further includes a hydrophobic porous gasket 180 that may form a seal between the top and bottom housings 120, 140 when they are interconnected. The hydrophobic porous gasket may be formed of any material that blocks the passage of liquid but allows the passage of gas. Non-limiting examples of the material may include PVDF (polyvinylidene fluoride), PTFE and Polypropylene.

The device 100 further includes an interconnect structure that is operable to interconnect the top and bottom housings 120, 140, with the gasket 180 disposed therebetween such that the housings and the gasket 180 cooperate to define an interior volume between the inner surface of the top housing 120 and the inner surface of the bottom housing 140. In certain embodiments, the interconnect structure is further operable to interconnect the top and bottom housings 120, 140 in at least two positions, a first position wherein the inner surfaces of the housings 120, 140 are spaced apart by a first distance and a second position wherein the inner surfaces are spaced apart by a second distance that is less than the first distance.

In the illustrated embodiment, the top and bottom housings 120, 140 are each generally cylindrical with a generally circular outer perimeter, but other shapes such as rectangular or triangular are possible. The outer perimeter 200 of the top housing 120 and the outer perimeter 220 of the bottom housing 140 are shown in FIG. 39. In this example, the outer perimeters have approximately the same diameter. Referring to FIG. 40, the outer perimeter 220 of the bottom housing 140 has two annular recesses 240 and 260 that are at different heights relative to an upper lip 280 of the bottom housing 140. In this embodiment, the interconnect structure includes three lock elements 300, extending from the outer perimeter 320 of the top housing 120, that selectively engage one of the annular recesses 240 or 260 in the bottom housing 140. In the first position, the lock elements 300 engage the upper recess 240. In the second position, the lock elements 300 engage the lower recess 260. The interconnect structure may take other forms, including one or more elements separate from the top and bottom housings 120, 140 and operable to interconnect the housings 120, 140.

FIG. 41 is a side view of the device 100 with the top housing 120 resting on top of the bottom housing 140, with the gasket 180 disposed therebetween. In FIG. 41, the lock elements 300 are above the annular recesses 240 and 260 and are not interconnecting the housings 120, 140. Instead, the lock elements 300 rest on the upper lip of the bottom housing 140. As shown in FIG. 41, each lock element 300 extends outwardly, then downwardly, then inwardly, with the inwardly extending portion acting to engage the recesses 240 or 260. The inwardly extending portion 340 terminates at an inward end having a beveled lower surface to allow each lock element 300 to be pushed outwardly as the top housing 120 is pushed toward the bottom housing 140, until the portion 340 engages the upper annular recess 240. Also in this embodiment, the upper lip 280 of the bottom housing 140 has a beveled upper surface to assist in the lock elements 300 moving down and into the recess 240. Likewise, the recess 240 has a beveled lower surface to allow the lock elements 300 to move down and into the lower recess 260 when the top housing 120 is pushed further towards the bottom housing 140. However, in this embodiment, the upper surface of the inwardly extending portion 340 has a flat upper surface, and the recesses 240 and 260 also have flat upper surfaces, to resist the lock elements 300 from being released and moving upwardly. As such, the movement of the housings 120, 140 into the first position and from the first position to the second position is configured to be a one-direction movement unless the lock elements 300 are manually spread apart to release the housings 120, 140 from one another.

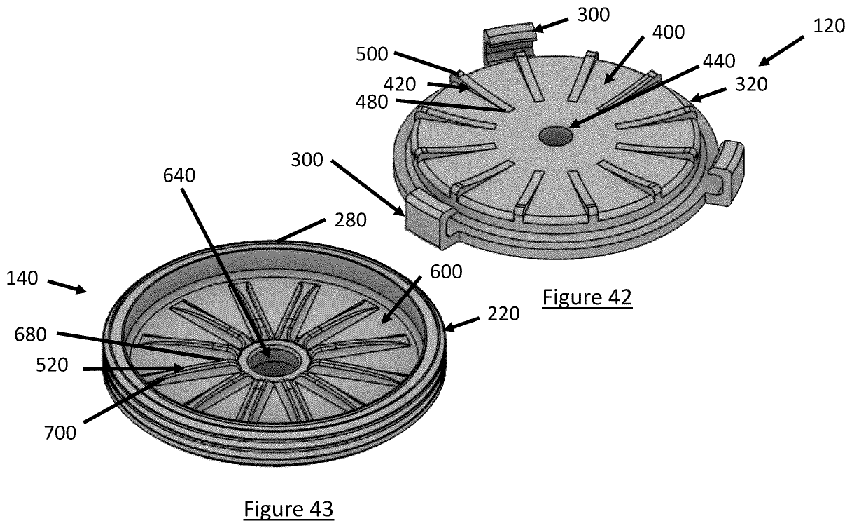

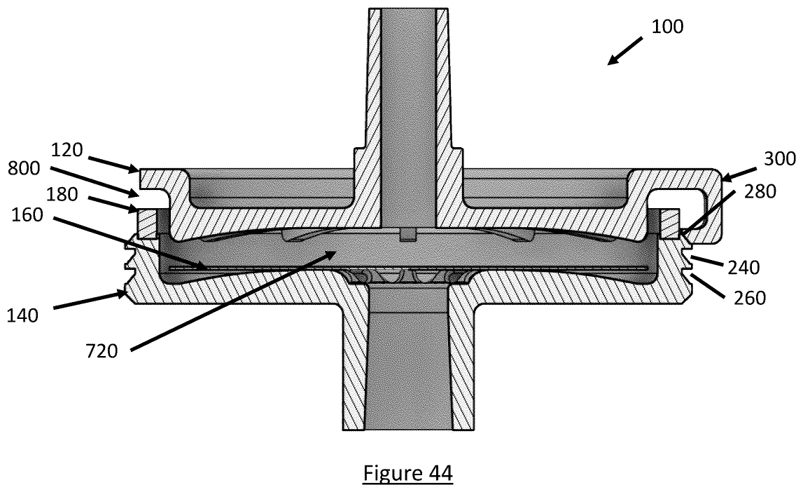

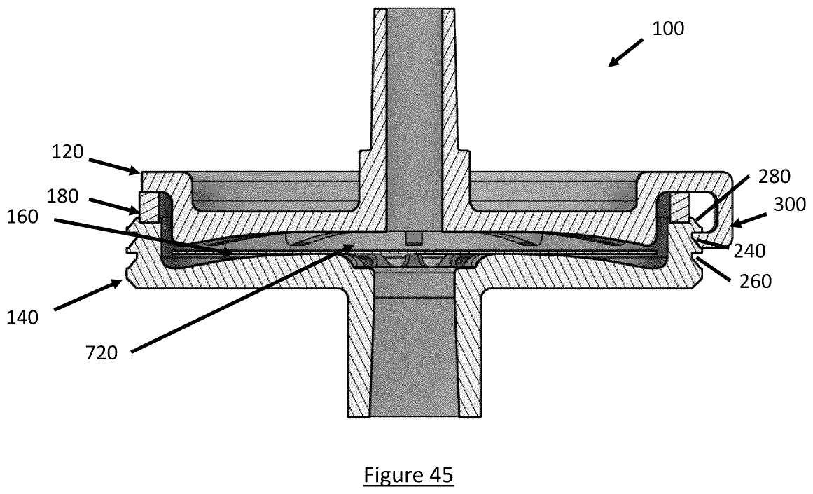

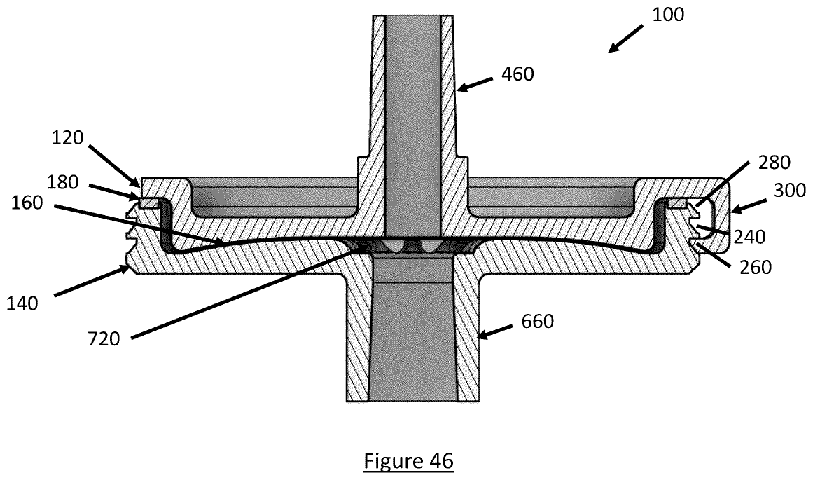

Referring now to FIGS. 42 and 43, further details of certain embodiments of the top housing 120 and the bottom housing 140 will be described. The top housing 120 has an inner surface 400 that faces the bottom housing 140 when the housings 120, 140 are interconnected. In this embodiment, the inner surface 400 is generally flat with a plurality of radially extending ribs 420 disposed around the perimeter 320. An opening 440 is defined in a central region of the inner surface 400 and communicates with a top tube 460, shown in FIG. 41. The top tube 460 provides fluid communication, through the opening 440, with the interior volume between the top and bottom housing 120, 140.

Referring again to FIG. 42, each of the ribs 420 has an inner end 480 that is spaced radially outwardly from the opening 440 has minimal height. Each rib 420 extends radially outwardly to an outer end 500 near or at an outer edge of the generally flat inner surface 400, with the outer end 500 having a height greater than the height of the inner end 480.

Referring now to FIG. 43, the bottom housing 140 has an inner surface 600 that is also generally flat and has a plurality of radially extending ribs 520 disposed around the perimeter 220. An opening 640 is defined in the central region of the inner surface 600 and fluidly communicates with a bottom tube 660, shown in FIG. 41. Referring again to FIG. 43, each rib 520 has an inner end 680 close to the opening 640 and an outer end 700 near the perimeter 220. These ribs 520 are configured oppositely to the ribs 420 of the top housing 120, with the outer ends 700 having minimal height and the inner ends 680 having a greater height.

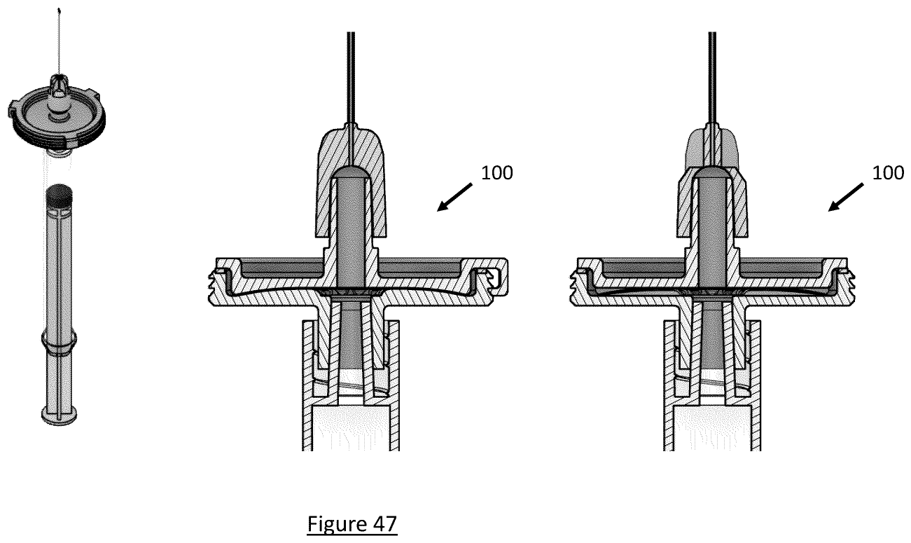

FIG. 44 provides a cross-sectional view of the device 100 with the top housing 120 resting on top of the bottom housing 140 but with the lock elements 300 (only one shown) resting on the upper lip 280. In this position, the top housing 120 has not been pressed toward the bottom housing 140 to engage the lock elements 300 with the upper recess 240 or lower recess 260. The gasket 180 rests on the upper lip 280 of the bottom housing 140 but is spaced from the top housing 120 so as to define an air gap 800 in communication with the interior volume 720 between the inner surfaces of the housings 120 and 140. The substrate 160 is disposed in the interior volume 720 and rests on the ribs 520 on the inner surface of the bottom housing 140. The position shown in FIG. 44 may be used for vitrification of bioactive agents into the substrate using any method known to those of skill in the art or that becomes known. The air passage allows for vitrification using processes such as vacuum drying, with or without heat. Vitrification of bioactive agents by dehydration in the presence of glass forming sugar trehalose has been disclosed in U.S. Pat. No. 10,433,540 and U.S. Provisional Patent Application No. 63/115,936, now PCT application WO/2022/109315, and the disclosed process may be used in embodiments.

FIG. 45 shows a similar cross-sectional view of the device 100 but with the lock elements 300 engaging the upper annular recess 240, putting the device 100 into a first position. The gasket 180 now seals the housings 120, 140 to one another but allows the passage of gas. The interior volume 720 may now be used to reconstitute the vitrified bioactive agents. As shown, in this embodiment in this position, the ribs 420 of the top housing 120 are spaced from the ribs 520 of the bottom housing 140.

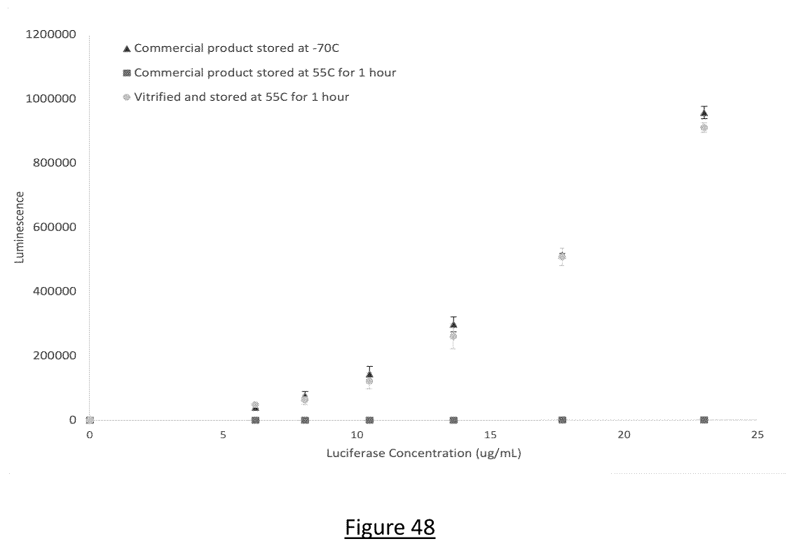

FIG. 46 shows a similar cross-sectional view of the device 100 but with the lock elements 300 engaging the lower annular recess 260, putting the device 100 into a second position wherein the size of the interior volume 720 is reduced. In this position, the substrate 160 is squeezed between the ribs 420, 520. This position may be used for administration of a reconstituted bioactive agent, such as by passing a liquid into the bottom tube 660 and out through the top tube 460. In some examples, the top tube 660 may receive a needle assembly for administration of the bioactive agent. The top tube 660 may also receive a cap for containing the bioactive agent. Likewise, the bottom tube 660 may receive a syringe or a cap.

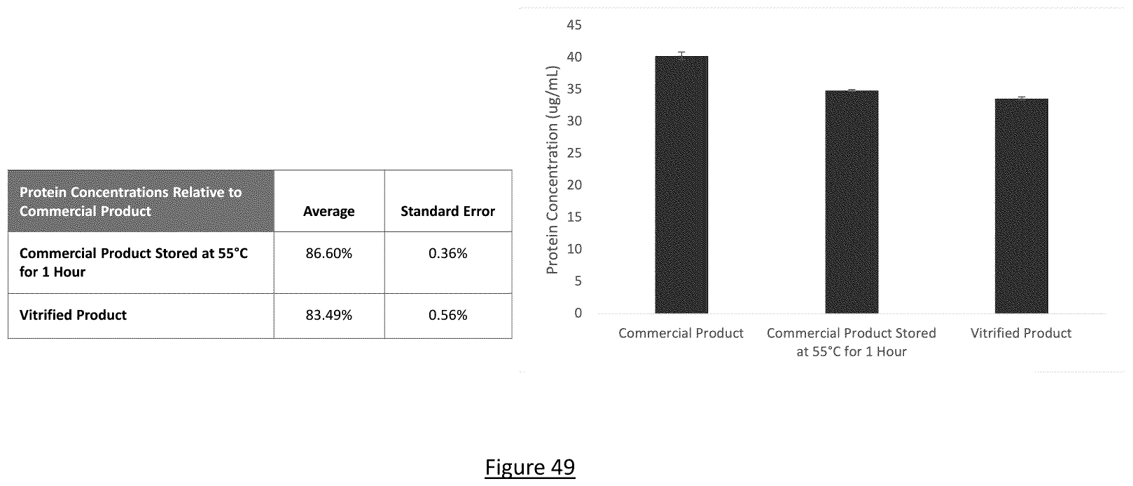

FIG. 47 provides views showing assembly of the device with a needle assembly and a syringe.

FIG. 48 is a graph showing Luciferase stabilization data and comparing a commercial product stored at a typical −70° C., the commercial product stored at 55° C. for one hour, and with Luciferase vitrified and stored at 55° C. using an apparatus and process as discussed above. As shown, the Luciferase vitrified and stored using the present apparatus and process performs nearly identically to the commercial product stored at −70° C. while the commercial product stored at 55° C. for an hour becomes unusable. The data in the graph was obtained as follows. For vitrification, 50 uL of luciferase in vitrification matrix was added to two devices as disclosed herein. The material added included 1.6 ug/uL luciferase, 600 mM Trehalose and 2.27% glycerol. This was vitrified at 37° C. for 30 minutes in a vacuum chamber. The samples were stored overnight at 55° C. As a heat-stressed liquid control, luciferase stock was diluted to 40 ug/mL in PBS (Phosphate-Buffered Saline) and stored at 55° C. {“Liquid Stored at 55° C.”). For reconstitution, 2 mL of PBS was injected into a device as described herein, and then withdrawn from the device. For the assay, a prepared reagent solution (0.5 mM ATP, 4.5 mM MgSO4, 1.5 mM Luciferin in 25 mM EPPS) was used. A fresh control was prepared by diluting stock luciferase to 40 ug/mL in PBS (“Liquid Stored at −70° C.”). A dilution series was prepared of the three sample types. 50 uL of luciferase dilutions and 50 uL of reagent was added to wells of a 96-well black plate, the samples were incubated at room temperature for 10 minutes, and luminescence was detected.

FIG. 49 shows the elution efficiency of luciferase vitrified as discussed herein as compared to a commercial product. This measurement is for total protein content, however, protein may not be functional after exposure to 55° C.

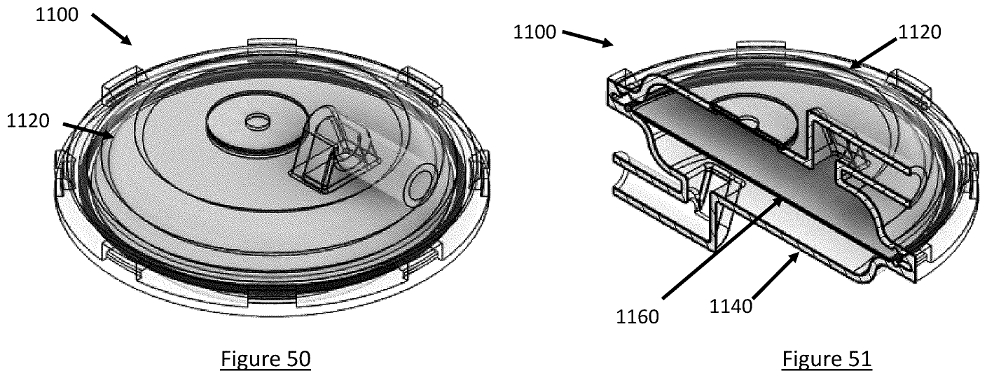

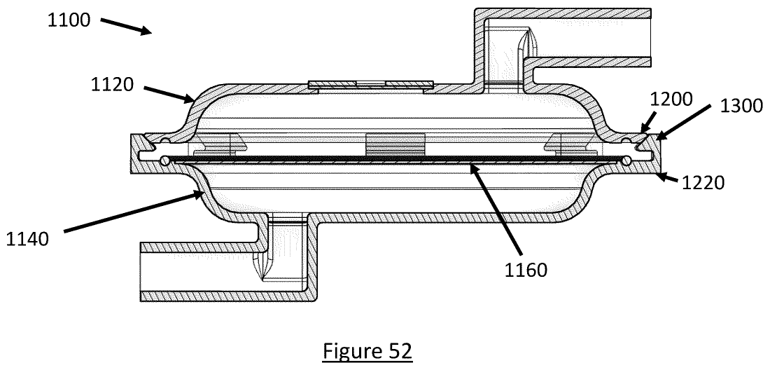

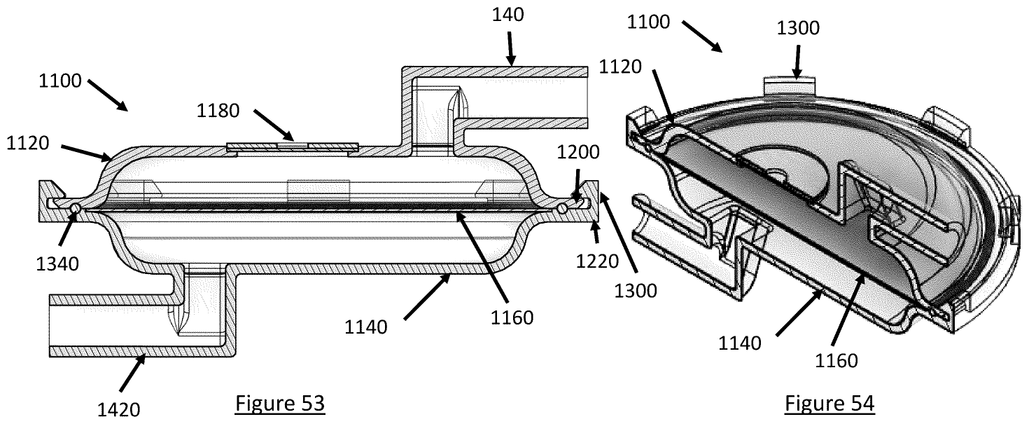

The above-discussed embodiment of the device may be modified for use with an IV, instead of as an injection. FIGS. 50-52 illustrate an embodiment of a device 1100 for vitrification, shipment, reconstitutions and administration by IV. FIG. 50 is a perspective view of the assembled device, with portions being partially transparent. FIG. 51 is a cross sectional perspective view of the device 1100 and FIG. 52 is a cross sectional schematic view of the device 1100. The device 1100 has a top housing 1120 defining an upper end of the device 1100 and a bottom housing 1140 defining a lower end of the device 1100 with the top and bottom housings 1120, 1140 configured to engage with one another to form the assembled device. It is noted that positions terms such as “upper”, “lower”, “top” and “bottom” are used herein to assist in describing an embodiment of the present invention but are not limiting. The device 1100 may be inverted or positioned differently than shown.

As best shown in FIGS. 51 and 52, the device 1100 further includes a substrate 1160, which may contain a vitrified bioactive agent. Alternatively, the substrate 1160 may be separately provided and not be considered part of the device 1100.

FIGS. 50-52 show the device 1100 with the top housing 1120 resting on the bottom housing 1140 and the substrate 1160 resting in the bottom housing 1140. As best shown in FIG. 52, the top housing 1120 has an outer perimeter 1200 and the bottom housing 1140 has an outer perimeter 1220. In this example, the outer perimeters 1220 have approximately the same diameter.

The device 1100 further has an interconnect structure that is operable to interconnect the top and bottom housings 1120, 1140 so as to seal the substrate 1160 in an interior volume between the housings 1120 and 1140. In this example, the interconnect structure is provided by a plurality of lock elements 1300 extending from the outer perimeter 1220 of the bottom housing 1140. These lock elements 1300 extend upwardly and then inwardly to tips with a sloped upper surface. The top housing 1120 is shown resting on these sloped tips in FIGS. 51 and 52. This is a vitrification position, in which vitrification of the substrate may be achieved.

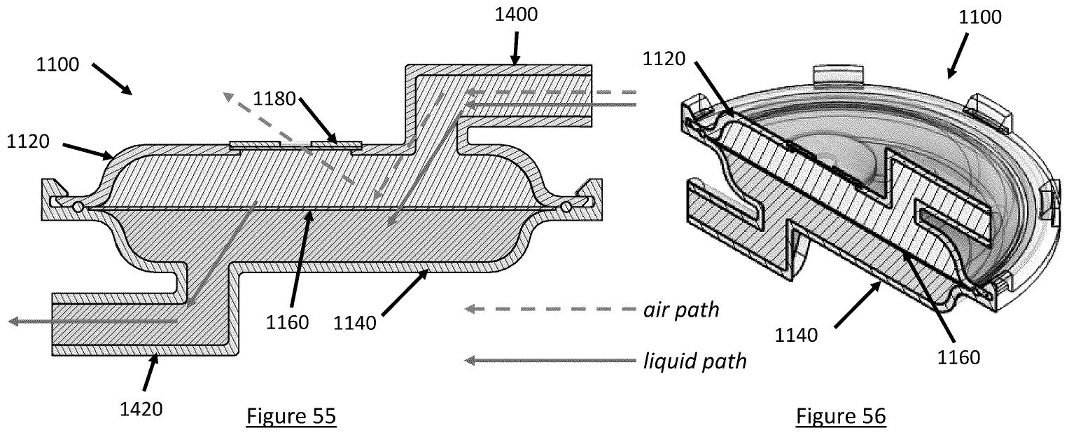

FIGS. 53 and 54 are similar to FIGS. 51 and 52 except that the top housing 1120 has been moved towards the bottom housing 1140 such that the lock elements 1300 engaged the outer perimeter 1200 of the top housing and seal it to the outer perimeter 1220 of the bottom housing 1140. An O-ring 1340 or other seal may be provided for sealing the housings to one another and/or to the substrate.

The position shown in FIGS. 53 and 54 is used for storing, shipping, reconstitution and administration.

The top housing 1120 includes an inlet 1400 and the bottom housing 1140 has an outlet 1420, with the inlet 1400 communicating with a volume in the top housing 1120 above the substrate 1160 and the outlet communicating with a volume in the bottom housing 1140 below the substrate 1160. The device 1100 further has a hydrophobic porous membrane 1180 in the top housing 1120. The hydrophobic membrane may be formed of any material that blocks the passage of liquid but allows the passage of gas.

FIGS. 55 and 56 illustrate reconstitution of the bioactive agent on the substrate 1160. A liquid is provided into the inlet 1400 in the top housing 1120. As illustrated by the arrows, gas in the interior volume may escape through the membrane 1180 while liquid flows through the substrate 1160 and out the outlet 1420. As such, the device 1100 may be used as an inline administration device.

Various modifications of the present disclosure, in addition to those shown and described herein, will be apparent to those skilled in the art of the above description. Such modifications are also intended to fall within the scope of the appended claims.

It is appreciated that all reagents are obtainable by sources known in the art unless otherwise specified.

It is also to be understood that this disclosure is not limited to the specific aspects and methods described herein, as specific components and/or conditions may, of course, vary. Furthermore, the terminology used herein is used only for the purpose of describing particular aspects of the present disclosure and is not intended to be limiting in any way. It will be also understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein. Similarly, as used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Reference is made in detail to exemplary compositions, aspects and methods of the present disclosure, which constitute the best modes of practicing the disclosure presently known to the inventors. The Figures are not necessarily to scale. However, it is to be understood that the disclosed aspects are merely exemplary of the disclosure that may be embodied in various and alternative forms. Therefore, specific details disclosed herein are not to be interpreted as limiting, but merely as a representative basis for any aspect of the disclosure and/or as a representative basis for teaching one skilled in the art to variously employ the present disclosure.

Patents, publications, and applications mentioned in the specification are indicative of the levels of those skilled in the art to which the disclosure pertains. These patents, publications, and applications are incorporated herein by reference to the same extent as if each individual patent, publication, or application was specifically and individually incorporated herein by reference.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

The foregoing description is illustrative of particular embodiments of the disclosure, but is not meant to be a limitation upon the practice thereof. The following claims, including all equivalents thereof, are intended to define the scope of the disclosure.

1-43. (canceled)

44. A device for vitrifying bioactive agents and delivering vitrified bioactive agents, comprising:
a top housing having an inner surface, an outer surface, and a perimeter;
a bottom housing having an inner surface, an outer surface, and a perimeter; and
an interconnect structure operable to interconnect the top housing and the bottom housing to define an interior volume between the inner surface of the top housing and the inner surface of the bottom housing,
wherein the bottom housing is formed of a flexible material such that the bottom housing is deformable between a first configuration wherein the bottom housing is curved away from the top housing, and a second configuration wherein the bottom housing is curved toward the top housing.

45. The device according to claim 44, wherein the interior volume of the device with the bottom housing in the first configuration is larger than the interior volume of the device with the bottom housing in the second configuration.

46. The device according to claim 44, wherein the perimeter of the top housing and the perimeter of the bottom housing are interconnected, the interconnect structure preferably including a lock element extending from the perimeter of the top housing, the bottom housing preferably including an engagement lip extending from the perimeter of the bottom housing, the engagement lip engaging with the lock element.

47. The device according to claim 44, further comprising a substrate disposed in the interior volume.

48. The device according to claim 47, wherein the substrate preferably being held between the perimeter of the top housing and the perimeter of the bottom housing.

49. The device according to claim 44, wherein:
the top housing includes a central port through which the interior volume is exposed;
further comprising a connector couplable to the central port, the connector preferably being sealable by a seal and/or the connector being configured to receive a syringe or a needle.

50. The device according to claim 44, further comprising a gasket disposed between the top housing and the bottom housing to form a seal between the top housing and the bottom housing when the top housing and the bottom housing are interconnected, the gasket preferably being hydrophobic and porous.

51. A device for vitrifying bioactive agents and delivering vitrified bioactive agents, comprising:
a top housing having an inner surface, an outer surface, and a perimeter;
a bottom housing having an inner surface, an outer surface, and a perimeter; and
an interconnect structure operable to interconnect the top housing and bottom housing to define an interior volume between the inner surface of the top housing and the inner surface of the bottom housing,
wherein the interconnect structure is operable to interconnect the top housing and the bottom housing in a first position wherein the inner surface of the top housing and the inner surface of the bottom housing are spaced apart by a first distance, and in a second position wherein the inner surface of the top housing and the inner surface of the bottom housing are spaced apart by a second distance that is less than the first distance.

52. The device according to claim 51, wherein a seal is formed between the top housing and the bottom housing when the top housing and the bottom housing are interconnected in the first position, and a seal is formed between the top housing and the bottom housing when the top housing and the bottom housing are interconnected in the second position, the interior volume in the second position being reduced in size compared to the first position.

53. The device according to claim 51, further comprising a gasket disposed between the top housing and the bottom housing and forming a seal between the top housing to the bottom housing when the top housing and the bottom housing are interconnected in the first and second position, the gasket preferably being hydrophobic and porous.

54. The device according to claim 51, further comprising a third position wherein the interconnect structure supports the top housing to be rested on the bottom housing to allow an air gap between the top housing and the bottom housing for vitrification.

55. The device according to claim 51, wherein:
the perimeter of the top housing and the perimeter of the bottom housing are interconnected in the second position; and/or
the interconnect structure includes a lock element extending from the perimeter of the top housing, the bottom housing preferably including a plurality of recesses extending from the perimeter of the bottom housing, the recesses selectively engaging with the lock element, the recesses optionally including a first recess and a second recess, the top housing and the bottom housing interconnecting in the first position when the lock element engages with the first recess, and the top housing and the bottom housing interconnecting in the second position when the lock element engages with the second recess.

56. The device according to claim 51, further comprising a substrate disposed in the interior volume.

57. The device according to claim 51, wherein:
the top housing including a top tube through which the interior volume is exposed; and/or
the bottom housing including a bottom tube through which the interior volume is exposed, the bottom tube preferably being sealable by a seal or configured to receive a syringe or a needle.

58. A method for delivering vitrified bioactive agents, comprising:
providing a device for delivering vitrified bioactive agents, comprising;
a top housing having an inner surface, an outer surface, and a perimeter;
a bottom housing having an inner surface, an outer surface, and a perimeter;
the top and bottom housing being interconnected to define an interior volume between the inner surface of the top housing and the inner surface of the bottom housing; and
a substrate disposed in the interior volume, the substrate including or supporting a vitrified bioactive agent;
introducing an administration solvent into the interior volume of the device; and
reconstituting the bioactive agent into the administration solvent.

59. The method of claim 58, wherein the device:
further comprises an interconnect structure operable to interconnect the top housing and the bottom housing; and/or
the substrate is held between the perimeter of the top housing and the perimeter of the bottom housing.

60. The method of claim 58, wherein:
the bottom housing is formed of a flexible material such that the bottom housing is deformable between a first configuration wherein the bottom housing is curved away from the top housing, and a second configuration wherein the bottom housing is curved toward the top housing, the interior volume being greater when the bottom housing is in the first configuration than when the bottom housing is in the second configuration; and
the method further comprising introducing the administration solvent into the interior volume with the bottom housing in the second configuration until the bottom housing deforms to the first configuration.

61. The method of claim 58, wherein:
the device further comprises an interconnect structure operable to interconnect the top housing and the bottom housing in a first position wherein the inner surface of the top housing and the inner surface of the bottom housing are spaced apart by a first distance, and in a second position wherein the inner surface of the top housing and the inner surface of the bottom housing are spaced apart by a second distance that is less than the first distance; and
a seal is formed between the top housing and the bottom housing when the top housing and the bottom housing are interconnected in the first position, and a seal is formed between the top housing and the bottom housing when the top housing and the bottom housing are interconnected in the second position, the interior volume in the second position being reduced in size compared to the first position.

62. The method according to claim 61, wherein the device further comprises a third position wherein the interconnect structure supports the top housing to be rested on the bottom housing to allow an air gap between the top housing and the bottom housing for vitrification.

63. The method of claim 62, further comprising:
introducing the administration solvent into the interior volume when the housings are in the first position; and/or
administering the reconstituted bioactive agent by moving the housings from the first position to the second position.

64. The method of claim 58, further comprising:
vitrifying the bioactive agent on the substrate with the substrate in the interior volume; and/or
withdrawing the bioactive agent with the administration solvent.

65. The method of claim 58, wherein the administration solvent is introduced into a portion of the interior volume between the substrate and the top housing.
